(19) United States
(12) Patent Application Publication
(10) Pub. No.: US 2025/0154352 A1
(43) Pub. Date: May 15, 2025

(54) POLYBUTYLENE TEREPHTHALATE COMPOSITION

(71) Applicant: BASF SE, Ludwigshafen (DE)

(72) Inventors: Zhen Ke Wei, Shanghai (CN); Qiong Jie Han, Shanghai (CN); Li Xia Wang, Shanghai (CN); Xi Lin, Shanghai (CN)

(21) Appl. No.: 18/838,642

(22) PCT Filed: Feb. 6, 2023
(86) PCT No.: PCT/EP2023/052788

§ 371 Date: Aug. 15, 2024

(30) Foreign Application Priority Data
Feb. 16, 2022 (WO) PCT/CN2022/76425

(51) Int. Cl. C08L 67/06; C08K 3/26; C08K 3/40; C08K 7/14

(52) U.S. Cl. CPC C08L 67/06; C08K 3/26; C08K 3/40; C08K 7/14; C08K 2003/262; C08L 2201/10

(57) ABSTRACT

Disclosed is a polybutylene terephthalate composition, comprising polybutylene terephthalate (PBT); amorphous polymer, in which the amorphous polymer has a refractive index of at least 1.55, and does not comprise carbonate group; alkali metal carbonate and/or bicarbonate; optionally glass fiber; and optionally additives. This polybutylene terephthalate composition exhibits greatly enhanced LT, in the meantime, balanced other properties are retained comparing with polybutylene terephthalate composition without such carbonate and/or bicarbon.

### FIELD OF THE INVENTION

The present invention relates to a polybutylene terephthalate composition.

### BACKGROUND OF THE INVENTION

In the automotive industry, sensors, electric control units (ECUs) etc. are normally assembled in housings preferably made of polybutylene terephthalate (PBT), due to its good mechanical properties and dimensional stability.

Laser welding is a joining process with cost-effective characteristics alternative to traditional techniques which involve screws and adhesives. The joining process is based on converting radiate energy into heat via its absorption within the material, resulting in local melting in the joining region. The basic requirement for laser welding is that the upper material should have good laser transparent rate for high welding speed.

Comparing with other semicrystalline engineering polymers, PBT has poor transmission for typical laser having wavelength of 1064 nm. Of the non-transmitted radiation, most is reflected and/or scattered. As a sequence, the laser welding process window is rather narrow, and the welding speed is limited. A highly infrared transmitted PBT for fast welding, i.e., short production cycle time, is demanded.

In order to enhance the laser transmittance of PBT composition, attempts are conducted to blend PBT with amorphous polymers. JP 2010-070626 discloses a polyester resin composition with excellent laser transmittance, comprising 29-84% by weight of PBT (A), 5-60% by weight of component (B) selected from polyester in which repeating units formed from terephthalic acid and 1,4-cyclohexanedimethanol accounting for 25 mol % or more, (C) 10-50% by weight of reinforcing fibers, (D) 1-20% by weight of block copolymer of polyalkyl methacrylate and butyl acrylate. However, the compatibility between the polyester resin and the amorphous resin is insufficient, and the laser transmittance needs to be improved.

Thermoplastic elastomer or epoxy resin is used to improve the compatibility between PBT and amorphous resin, and further improve the laser transmittance.

CN1863870A discloses a PBT resin composition for laser welding which can be evenly welded to attain high weld strength. This laser-weldable resin composition comprises 100 parts by weight of PBT (A), 1 to 50 parts by weight of an elastomer such as a thermoplastic polystyrene elastomer or thermoplastic polyester elastomer, 5 to 100 parts by weight of a polycarbonate resin (C), 1 to 10 parts by weight of a plasticizer, and 0 to 100 parts by weight of a filler or reinforcement (E), such as glass fibers. This resin composition gives a molded article in which the light transmittance fluctuates little from part to part. This molded article can hence be evenly laser-welded to a mating material. However, the laser transmittance is not enhanced obviously.

WO 2021/013115A discloses a polyester resin composition comprising PBT, amorphous resin, and epoxy resin selected among triphenol methane type, tetraphenol ethane type, novolac type, and naphthalene type epoxy resins, and additives. However, in order to achieve high laser transmittance at 1 mm (which is about 1.5 times of laser transmittance at 2 mm), high loading of amorphous resin is needed (Example 5) in WO 2021/013115A; under such a situation, the heat distortion temperature (HDT) and chemical resistance performance thereof will therefore decline inevitably.

There is always a need for increasing the laser transmittance of the PBT composition as much as possible, meantime, the overall performance thereof should at least retain unchanged.

### SUMMARY OF THE INVENTION

The inventor surprising found that, by combining base resin PBT with specially selected amorphous polymers like PS, PETG and etc., and by further particularly combining with alkali metal carbonate and/or bicarbonate, laser transmittance of the PBT composition can be increased greatly, in the meantime, balanced other properties can be retained comparing with polybutylene terephthalate composition without such alkali metal carbonate and/or bicarbonate.

In accordance with the invention, it is provided a PBT composition, comprising:
(A) polybutylene terephthalate resin,
(B) amorphous polymer having a refractive index of at least 1.55 and having no carbonate group in the repeating units of the amorphous polymer,
(C) alkali metal carbonate and/or bicarbonate,
(D) optionally glass fiber, and
(E) optionally additives.

The present invention also provides an article produced from the polybutylene terephthalate composition as described herein, the article is laser weldable, and preferably is sensor, electric control unit, or advanced driver assistance system (ADAS) device for automobile, etc.

The present invention also provides an application of alkali metal carbonate and/or bicarbonate in improving laser transmittance of polybutylene terephthalate composition.

### DETAILED DESCRIPTION OF THE INVENTION

The present invention will be described in detail hereinafter. It is to be understood that the present invention may be embodied in many different ways and shall not be construed as limited to the embodiments set forth herein.

Except in the examples, or where otherwise explicitly indicated, all numbers in this description indicating amounts of material or conditions of reaction, physical properties of materials and/or use may optionally be understood as modified by the word “about”.

All amounts are by weight of the final composition, unless otherwise specified.

It should be noted that in specifying any range of values, a given upper value can be associated with any lower value.

For the avoidance of doubt, the word “comprising” is intended to mean “including” but not necessarily “consisting of” or “composed of”. In other words, the listed steps or options need not be exhaustive.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

The terms “polybutylene terephthalate” and “polybutylene terephthalate composition” herein may also be referred to as “PBT” and “PBT composition” as abbreviations respectively.

In accordance with the invention, it is provided a PBT composition, comprising:
(A) polybutylene terephthalate resin,
(B) amorphous polymer having a refractive index of at least 1.55 and having no carbonate group in the repeating units of the amorphous polymer,
(C) alkali metal carbonate and/or bicarbonate,
(D) optionally glass fiber, and
(E) optionally additives.

In accordance with the invention, the term “carbonate group” used herein is represented by the formula OC(O)OR, where R can be hydrogen, an alkyl, alkenyl, alkynyl, aryl, aralkyl, cycloalkyl, halogenated alkyl, or heterocycloalkyl group.

The polybutylene terephthalate composition according to the present invention contains a polybutylene terephthalate resin (A). Polybutylene terephthalate (PBT) resin [CAS No.24968-12-5] according to the invention is produced from terephthalic acid or the reactive derivatives thereof and butanediol by known methods, such as those described in Kunststoff-Handbuch, Vol. VIII, p. 695 ff, Karl Hanser Verlag, Munich 1973.

Polybutylene terephthalate is known as a crystalline or semicrystalline thermoplastic polymeric material, for example derived from polycondensation of 1,4-butanediol with terephthalic acid via esterification or with an ester of terephthalic acid via transesterification.

There is no particular restriction to the PBT resin useful in the polybutylene terephthalate composition according to the present invention. The polybutylene terephthalate resin includes a homo-polyester or co-polyester of polybutylene terephthalate (a polybutylene terephthalate, a polybutylene terephthalate co-polyester). There is no limitation of the type of the co-polyester, including for example block copolymer, random copolymer, graft copolymer and alternating copolymer. The polybutylene terephthalate resin contains a butylene terephthalate as a main component, which is obtainable by a common method, for example by the polycondensation of polymerization monomers comprising a first dicarboxylic acid component including at least one terephthalic acid and/or the ester derivative thereof and a first glycol component including at least one 1,4-butane diol and/or the ester derivative thereof. 1,4-butane diol could be in the form of renewable or recycled raw material. Any known polybutylene terephthalate resin could be used in the present invention, the present invention is not limited to crystallization property, kind or amount of a terminal group of the polybutylene terephthalate, intrinsic viscosity, molecular weight, linear or branched structure, kind or amount of a polymerization catalyst, and a polymerization method.

PBT resin can include units derived from other monomers excluding terephthalic acid, the ester derivatives thereof, 1,4-butane diol or the ester derivatives thereof within the range not impairing the characteristics. For example, the other monomers are preferable in an amount of less than or equal to 40 mol %, particularly less than or equal to 20 mol %, based on the total monomers constituting the polybutylene terephthalate resin.

Examples of the other monomers include aliphatic dicarboxylic acids having up to 20 carbon atoms, cycloaliphatic dicarboxylic acids having 7 to 12 carbon atoms, aromatic dicarboxylic acids having 8 to 16 carbon atoms and their respective ester-forming derivatives, preferably is selected from the group consisting of succinic acid, glutaric acid, adipic acid, pimelic acid, suberic acid, sebacic acid, azelaic acid, undecanedicarboxylic acid, dodecanedicarboxylic acid, tridecanedioic acid, tetradecanedioic acid, pentadecanoic acid, hexadecanedicarboxylic acid, dimeric acid, isophthalic acid, phthalic acid, 2,6-naphthalene dicarboxylic acid, hexahydrophthalic acid, hexahydroisophthalic acid, hexahydroterephthalic acid, 1,2-cyclopentanedicarboxylic acid, 1,3-cyclopentanedicarboxylic acid, himic acid, 4,4′-diphenyldicarboxylic acid, 4,4′-diphenyletherdicarboxylic acid, 4,4′-diphenylmethanedicarboxylic and acid 4,4′-diphenylketonedicarboxylic acid, more preferably is succinic acid, glutaric acid, adipic acid, pimelic acid, isophthalic acid, phthalic acid or their ester-forming derivatives. These other monomers may be used singly alone, or by mixing two or more kinds thereof. Succinic acid, azelaic acid, and sebacic acid have the additional advantage of being available in the form of renewable raw materials.

Examples of the other monomers include aliphatic glycol having 2 to 12 carbon atoms, cycloaliphatic glycol having 5 to 12 carbon atoms, polyoxyalkylene glycol having a plurality of oxyalkylene units of which the carbon atom number is 2 to 4, and/or aromatic glycol having 6 to 14 carbon atoms, preferably is selected from the group consisting of ethylene glycol, propylene glycol, 1,3-butylene glycol, trimethylene glycol, 1,6-hexanediol, neopentanediol, 1,3-octanediol, diethylene glycol, triethylene glycol, dipropylene glycol, tripropylene glycol, ditetramethylene glycol, decanediol, 1,4-cyclohexanediol, 1,4-cyclohexanedimethanol, bis-1,4-(hydroxymethyl)cyclohexane, diethylene glycol, polytetramethylene glycol, bisphenols, xylylene glycol and naphthalenediol, more preferably is ethylene glycol and/or diethylene glycol. These other monomers may be used singly alone, or by mixing two or more kinds thereof. 1, 3-butylene glycol has the additional advantage of being available in the form of renewable raw material.

Examples of the PBT resin include polybutylene terephthalate, polybutylene(terephthalate/isophthalate), polybutylene (terephthalate/adipate), polybutylene (tereph-thalate/sebacate), polybutylene (terephthalate/decane dicarboxylate), polybutylene (tereph-thalate/naphthalate) and poly(butylene/ethylene) terephthalate.

The viscosity number of PBT resin is suitable in the range from 90 to 170 cm³/g, preferably from 100 to 135 cm³/g, more preferably from 100 to 120 cm³/g, measured in a 0.005 g/ml phenol/1,2-dichlorobenzene solution (1:1 mass ratio), according to ISO 1628-5.

The PBT may have a weight average molecular weight (Mw) of from 60,000 to 100,000 as measured by gel permeation chromatography (GPC).

Any PBT resin prepared via known processes or any commercially available PBT materials suitable as engineering plastics may be used for the purpose of the present invention. Examples of commercially available PBT materials include, but are not limited to, Ultradur® series from BASF, BLUESTAR® series from Bluestar, Crastin® series from DuPont, Pocan® series from Lanxess, NOVADURAN® series from Mitsubishi, LNP™ LUBRICOMP™ series and VALOX™ series from SABIC, RAMSTER® series from Polyram, and Toraycon® series from Toray.

The PBT resin derived from a bio-based raw material may be used in the present invention. The recycled PBT resin could also be used in the present invention.

It is to be understood that the amount of PBT when mentioned herein is intended to refer to the amount of PBT per se. Commercially available PBT materials often have been already intentionally added with certain additive(s) to provide one or more desired properties such as color, strength, stability and the like, which additive(s) will not be accounted in the amount of PBT.

It is preferred that PBT resin (A) is present in the PBT composition according to the present invention in an amount of from 10 wt. % to 90 wt. %, preferably from 20 wt. % to 80 wt. %, more preferably from 40 wt. % to 80 wt. %, for example 35 wt. %, 40 wt. %, 45 wt. %, 50 wt. %, 55 wt. %, 60 wt. %, 65 wt. %, 70 wt. %, 75 wt. %, 80 wt. %, based on the total weight of the PBT composition.

The amorphous polymer (B) used in the present invention refers to a polymer having a refractive index of at least 1.55 and having no carbonate group in the repeating units of the amorphous polymer. The refractive index is determined at 25° C. and wavelength of 589 nm according to ASTM D542. The amorphous polymer (B) preferably has a refractive index of 1.55-1.6.

In accordance with the invention, the term “carbonate group” used herein is represented by the formula OC(O)OR, where R can be hydrogen, an alkyl, alkenyl, alkynyl, aryl, aralkyl, cycloalkyl, halogenated alkyl, or heterocycloalkyl group. The example of amorphous polymer having carbonate group is polycarbonate.

The amorphous polymer in the present invention refers to the polymer that has no crystalline domains or essentially no crystalline domains between macromolecular chains; as demonstrated by lack of melting peak or the presence of a melting peak with a melting enthalpy of less than 5 J/g, as measurable, for example, by Differential Scanning Calorimetry (DSC). The melting enthalpy is expressed relative to the weight of polymer.

Examples of the amorphous polymer (B) having a refractive index of at least 1.55 and having no carbonate group in the repeating units are selected from the group consisting of polystyrene (PS), styrene-acrylonitrile copolymer (SAN), amorphous co-polyesters, etc.

The polystyrene comprises units derived from 50 mol % to 100 mol %, preferably from 60 mol % to 99.5 mol %, most preferably from 70 mol % to 99.5 mol % of at least one monomer having the Formula I, based on the total units of polystyrene:

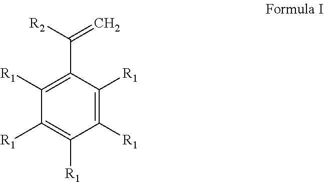

wherein R₁ is same or different and is selected from the group consisting of hydrogen, C₁-C₁₀ alkyl group, C₁-C₆ alkenyl group, C₄-C₁₀ cycloaliphatic group, C₆-C₁₂ aromatic hydrocarbon group, C₁-C₄ alkoxy group and halogen atoms, preferably is hydrogen, C₁-C₁₀ alkyl group and/or halogen atoms, more preferably is hydrogen and/or C₁-C₄ alkyl group, most preferably is hydrogen, methyl group and/or ethyl group; R₂ is hydrogen and/or C₁-C₄ alkyl group, preferably is hydrogen, methyl group and/or ethyl group.

Examples of Formula I are styrene, alpha-methylstyrene, 2-methylstyrene, 3-methylstyrene, 4-methylstyrene, 2,4-dimethylstyrene, 2,5-dimethylstyrene, para-alpha-dimethylstyrene, 2-ethylstyrene, 3-ethylstyrene, 4-ethyl styrene, 2-isopropyl styrene, 3-isopropyl styrene, 4-isopropyl styrene, ortho-divinylbenzene, meta-divinylbenzene, para-divinylbenzene, ethoxy styrene, chlorostyrene, bromostyrene, dibromostyrene, dichlorostyrene, tribromostyrene, trichlorostyrene, 2-vinylnaphthalene and 2-isopropenylnaphthalene, preferably is styrene, alpha-methylstyrene, 4-methylstyrene, chlorostyrene, para-divinylbenzene, bromostyrene, dibromostyrene, trichlorostyrene, 2-vinylnaphthalene and/or 2-isopropenylnaphthalene, more preferably is styrene, alpha-methylstyrene and/or 4-methylstyrene.

As the most widely used types of polystyrenes, homo-polystyrene is commercially available from a large number of manufacturers or suppliers around the world; among which, BASF SE, Shell chemicals, Dow Chemicals, Sinopec are on the list of main suppliers.

Generally, the molecular weight of polystyrene could range from 50,000 to 300,000 Daltons, preferably from 100,000 to 200,000 Daltons, as measured by GPC.

Styrene-acrylonitrile copolymer according to the invention refers to copolymers derived from vinyl aromatic monomer and vinyl cyanide monomer.

It is preferable when 100 parts by mass of a styrene-acrylonitrile copolymer comprise
(B.1) 50 to 99 parts by mass of vinyl aromatic monomer and/or ring-substituted vinyl aromatic monomer, and
(B.2) 1 to 50 parts by mass of vinyl cyanide monomer, based on the total parts by mass of monomers of styrene-acrylonitrile copolymer.

Preferred compound (B.1) is selected from the group consisting of styrene, alpha-methyl styrene, p-methylstyrene, and p-chloro-styrene. Preferred vinyl cyanide monomer is unsaturated nitrile, in particular acrylonitrile or methacrylonitrile.

Styrene-acrylonitrile copolymer could also contain (B.3): C₁-C₈ alkyl methacrylates, in particular methyl methacrylate, ethyl methacrylate, n-butyl acrylate, t-butyl acrylate, or derivatives of unsaturated carboxylic acids. Preferred derivatives of unsaturated carboxylic acids are anhydrides or imides thereof, in particular maleic anhydride or n-phenyl maleimide.

Very particularly preferred monomers of styrene-acrylonitrile copolymer are styrene and acrylonitrile. Especial preference is given to a styrene-acrylonitrile copolymer known as SAN and having CAS No. 9003-54-7 which is commercially available from, for example, Styro lution GmbH, Frankfurt am Main, etc.

Also, suitable according to the invention as the amorphous polymer are also styrene-acrylonitrile copolymers and/or α-methylstyrene-acrylonitrile copolymers which contain methyl acrylate, ethyl acrylate or n-butyl acrylate as further comonomer.

Examples of styrene-acrylonitrile copolymer are styrene/acrylonitrile copolymers (SAN copolymer), α-methylstyrene/acrylonitrile copolymers (AMSAN copolymer), styrene acrylonitrile-maleic anhydride copolymers, styrene-acrylonitrile-phenylmaleimide copolymers, α-methylstyrene-acrylonitrile-methyl methacrylate copolymers, α-methyl-styrene-acrylonitrile-t-butylmethacrylate copolymers, and styrene-acrylonitrile-t-butylmethacrylate copolymers.

SAN copolymers and α-methylstyrene-acrylonitrile copolymers (AMSAN) used according to the invention as the amorphous polymer generally contain from 18 to 35 wt. %, preferably from 20 to 32 wt. %, particularly preferably from 22 to 30 wt. % of acrylonitrile (AN), and from 82 to 65 wt. %, preferably from 80 to 68 wt. %, particularly preferably from 78 to 70 wt.-% of styrene(S) or α-methylstyrene (AMS), wherein the sum of styrene or α-methylstyrene and acrylonitrile is 100 wt. %.

Suitable SAN copolymers are commercially available under Luran® from the company Styrolution. Preference is given to SAN copolymers having a S/AN ratio (in weight percent) of 82/18 to 67/33 and an MVR (measured according to ISO 1133 at 220° C. and 10 kg load) of at least 10 ml/10 min, for example Luran 368. Also preferred are SAN copolymers having a S/AN ratio (in weight percent) of 81/19 to 65/35 and an MVR (measured to ISO 1133 at 220° C. and 10 kg load) of at least 8 ml/10 min as for example, Luran M60, Luran VLL1970, Luran 25100, Luran VLP, and Luran VLR. Among the aforementioned SAN copolymers, particular preference is given to those having an MVR of at least 10 ml/10 min.

The styrene-acrylonitrile copolymer used according to the invention generally have an average molecular weight Mw of 150,000 to 350,000, preferably 150,000 to 300,000, more preferably 150,000 to 250,000, and most preferably 150,000 to 200,000, as measured by gel permeation chromatography (GPC).

Amorphous copolyester in the present invention refers to a copolyester having at least two different repeating units (RP₁ and RP2) in a combined amount of at least 55 mol %, preferably at least 80 mol %, more preferably at least 90 mol %, based on the total repeating units of the copolyester. The repeating unit RP₁ is derived from glycol and dicarboxylic acid, the dicarboxylic acid includes terephthalic acid and optionally other dicarboxylic acid. The repeating unit RP₂ is derived from glycol and dicarboxylic acid. The mole ratio of the glycol in the RP₁ to the glycol in the RP₂ is preferably from 2:8 to 8:2.

The glycol in the RP₁ or RP₂ can be aliphatic glycol having 2 to 12 carbon atoms, and/or cycloaliphatic glycol having 4 to 12 carbon atoms, respectively. The aliphatic glycol having 2 to 12 carbon atoms is preferably selected from the group consisting of ethylene glycol, propylene glycol, 1,3-butylene glycol, trimethylene glycol, 1,6-hexanediol, neopentanediol, neopentyl glycol, 1,3-octanediol, diethylene glycol, triethylene glycol, dipropylene glycol, tripropylene glycol, ditetramethylene glycol and decanediol, more preferably is ethylene glycol, diethylene glycol and/or neopentyl glycol. The cycloaliphatic glycol having 4 to 12 carbon atoms is preferably selected from the group consisting of 1,2-cyclobutanediol, 1,3-cyclobutanediol, 1,4-cyclohexanediol, 1,4-cyclohexanedimethanol and bis-1,4-(hydroxymethyl)cyclohexane, more preferably is 1,4- cyclohexanediol and/or 1,4-cyclohexanedimethanol. These other monomers may be used singly alone, or by mixing two or more kinds thereof.

The other dicarboxylic acid in RP₁ or the dicarboxylic acid in RP₂ can be aliphatic dicarboxylic acids having 2 to 20 carbon atoms, cycloaliphatic dicarboxylic acids having 7 to 12 carbon atoms, and/or aromatic dicarboxylic acids, respectively. The aliphatic dicarboxylic acid having 2 to 20 carbon atoms is preferably selected from succinic acid, glutaric acid, adipic acid, pimelic acid, suberic acid, sebacic acid, azelaic acid, undecanedicarboxylic acid, dodecanedicarboxylic acid, tridecanedioic acid, tetradecanedioic acid, pentadecanoic acid and hexadecanedicarboxylic acid, more preferably is succinic acid, glutaric acid, adipic acid and pimelic acid. The cycloaliphatic having 7 to 12 carbon atoms is preferably selected from the group consisting of 1,2-cyclohexanedicarboxylic acid, 1,3-cyclohexanedicarboxylic acid, 1,4-cyclohexanedicarboxylic acid, 1,2-cyclopentanedicarboxylic acid and 1,3-cyclopentanedicarboxylic acid. The aromatic dicarboxylic acid is preferably selected from the group consisting of terephthalic acid, isophthalic acid and phthalic acid. The other dicarboxylic acid excludes terephthalic acid. These other monomers may be used singly alone, or by mixing two or more kinds thereof. The glycol in the RP₁ is preferably aliphatic glycol having 2 to 12 carbon atoms, more preferably is ethylene glycol, diethylene glycol and/or neopentyl glycol; and the glycol in the RP₂ is preferably cycloaliphatic glycol having 6 to 12 carbon atoms, preferably is 1,4-cyclohexanediol and/or 1,4-cyclohexanedimethanol. The dicarboxylic acid in the RP₁ and RP₂ is preferably terephthalic acid.

In one embodiment of the present invention, RP₁ is derived from ethylene glycol and terephthalic acid, RP₂ is derived from 1,4-cyclohexanedimethanol and terephthalic. The molar ratio of ethylene glycol to 1,4-cyclohexanedimethanol is preferably 8:2 to 7:3. This amorphous copolyester is also called as PETG (cyclohexanedimethylene modified poly(ethylene terephthalate)).

In another embodiment of the present invention, RP₁ is derived from ethylene glycol and terephthalic acid, RP₂ is derived from 1,4-cyclohexanedimethanol and terephthalic. The molar ratio of ethylene glycol to 1,4-cyclohexanedimethanol is preferably 2:8 to 3:7. This amorphous copolyester is also called as PCTG (ethylene modified poly(1,4-cyclohexanedimethylene terephthalate)).

In another embodiment of the present invention, amorphous copolyester is PETG, PCTG or their mixture.

PETG and PCTG are commercially available from suppliers, such as Eastman, SK Chemical. For example, PETG S2008 from SK chemical, PETG 6763, PCTG 5445 from Eastman, can be suitably adopted in the present application.

It is preferred that the amorphous polymer (B) is present in the PBT composition according to the present invention in an amount of from 1 wt. % to 50 wt. %, preferably from 5 wt. % to 40 wt. %, more preferably from 5 wt. % to 35 wt. %, for example 5 wt. %, 10 wt. %, 15 wt. %, 20 wt. %, 25 wt. %, 30 wt. %, 35 wt. %, 40 wt. %, based on the total weight of the PBT composition.

Alkali metal carbonate or bicarbonate (C) according to the present invention refer to a salt comprising an anion moiety of carbonate (CO₃²⁻) or bicarbonate (HCO₃²⁻), and a cation moiety of alkali metal(s), the later selecting from lithium (Li), Sodium (Na), potassium (K), Rubidium (Rb), Cesium (Cs), francium (Fr). Sodium and potassium are preferred for the cation moiety, sodium is the most preferred. Alkali metal carbonate or bicarbonate is preferable selected from the group consisting of sodium carbonate, sodium bicarbonate, potassium carbonate and potassium bicarbonate.

It is preferred that alkali metal carbonate or bicarbonate (C) is present in the PBT composition according to the present invention in an amount of from 0.01 wt. % to 10 wt. %, preferably from 0.01 wt. % to 5 wt. %, more preferably from 0.01 wt. % to 2 wt. %, most preferably from 0.05 wt. % to 0.5 wt. %, for example 0.1 wt %, 0.15 wt %, 0.2 wt %, 0.3 wt. %, 0.4 wt %, 0.5 wt. %, 0.8 wt. %, based on the total weight of the PBT composition.

The PBT composition according to the present invention could further comprise glass fiber (D) as reinforcing material. Glass fibers are materials made from extremely fine fiber of glass which is a non-crystalline material. Due to the different sources of the raw material glass, the basic composition of glass fiber may differ from each other.

Glass fiber could be selected from the group consisting of E-glass fibers, A-glass fibers, D-glass fibers, AR-glass fibers, C-glass fibers, and S-glass fibers, more preferably is E-glass fiber and/or D-glass fiber, most preferably is E-glass fiber. The cross sections of the glass fiber can be circular or non-circular, e.g., rectangle, ellipse, cocoon, preferably is circle.

E-glass fiber (E-GF) derives from E glass, which is composed primarily of the oxides of calcium, aluminum, and silicon. According to ASTM D578, the detailed components of E glass fiber are: B₂O₃ 0 to 10 wt. %, CaO and MgO 16 to 30 wt. %, Al₂O₃ 12 to 16 wt. %, SiO₂ 52 to 62 wt. %, total alkali metal oxides 0 to 2 wt. %, TiO₂ 0 to 1.5 wt. %, Fe₂O₃ 0.05 to 0.8 wt. %, fluoride 0 to 1 wt. %; preferably, B₂O₃ 5 to 10 wt. %, CaO 16 to 25 wt. %, Al₂O₃ 12 to 16 wt. %, SiO₂ 52 to 56 wt. %, MgO 0 to 5 wt. %, Na₂O and K₂O 0 to 2 wt. %, TiO2 0 to 0.8 wt. %, Fe₂O₃ 0.05 to 0.4 wt. %, fluoride 0 to 1 wt. %, based on the total weight of the glass fiber.

D-glass fiber (D-GF) derives from borosilicate glass, and is named for its low dielectric constant, and is mainly composed of B₂O₃ 21-24 wt. %, CaO 0-1 wt. %, Al₂O₃ 0 to 1 wt. %, SiO₂ 72-75 wt. %, Na₂O and K₂O 0 to 4 wt. %, Fe₂O₃ 0 to 0.3 wt. %, based on the total weight of the glass fiber.

The fiber length and the fiber diameter of the glass fiber are not particularly limited. The fiber length is preferably from 1 to 10 mm and more preferably from 2 to 6 mm. The fiber diameter is preferably from 3 to 20 μm, more preferably from 7 to 13 μm. Examples of the cross-sectional shape of the fibrous reinforcing agent include a circle, a rectangle, an ellipse, cocoon, and other non-circular cross sections, preferably is circle. The glass fiber in the PBT composition is preferably in a length of 200-450 um, more preferably of 220-350 um, most preferably of 220-300 um.

The glass fibers are preferably surface-treated by a silane coupling agent, such as vinylsilane-based coupling agents, acrylic silane-based coupling agents, epoxysilane-based coupling agents and aminosilane-based coupling agents; preferable is aminosilane-based coupling agents. The silane coupling agent may be dispersed in a sizing agent. Examples of the sizing agents are acrylic compounds, acrylic/maleic derivative modified compounds, epoxy compounds, urethane compounds, urethane/maleic derivative modified compounds and urethane/amine modified compounds.

It is preferred that the glass fiber (D) in the present PBT composition in an amount of from 0 wt. % to 50 wt. %, preferably from 10 wt. % to 40 wt. %, more preferably from 20 wt. % to 35 wt. %, for example 5 wt. %, 10 wt. %, 15 wt. %, 20 wt. %, 25 wt. %, 30 wt. %, 35 wt. %, 40 wt. %, based on the total weight of the PBT composition.

The PBT composition according to the present invention may further comprise one or more additives (E), for example release agents, impact modifier, thermostabilizers, compatibilizing agents, stabilizers, lubricants, reinforcing agents, antioxidants, photostabilizers, plasticizers, colorants such as dyes and/or pigments, surfactants, nucleating agents, coupling agents, anti-microbial agents, antistatic agents, and the like. The additives may be used in conventional amounts. For example, the PBT composition may include one or more additives in an amount of 0.01 to 15 wt. % based on the total weight of the PBT composition.

The PBT composition may for example comprise a lubricant or a processing aid. Suitable lubricant or processing agent is preferably an ester or amide of saturated aliphatic carboxylic acids having from 10 to 40 carbon atoms and/or saturated aliphatic alcohols or amines having from 2 to 40 carbon atoms. The lubricant is preferably pentaerythritol esters of fatty acid having 10 to 20 carbon atoms, more preferably pentaerythritol tetrastearate.

The lubricant, when present, may be in an amount of 0.01 to 3 wt. %, or about 0.01 to 2 wt. %, or about 0.2 to 1 wt. %, based on the total weight of the PBT composition.

The PBT composition may for example comprise an antioxidant. Suitable antioxidants are aromatic amine-based antioxidants, hindered phenol-based antioxidants and phosphite-based antioxidants, particularly hindered phenol-based antioxidants. Examples of hindered phenol-based antioxidants include α-[3-[3,5-bis(1, 1-dimethylethyl)-4-hydroxyphenyl]-1-oxopropyl]-ω-[3-[3,5-bis(1, 1-dimethylethyl)-4-hydroxyphenyl]-1-oxopropoxy]poly (oxy-1,2-ethanediyl), 2,4-bis[(octylthio)methyl]-o-cresol, octyl-3,5-di-tert-butyl-4-hydroxy-hydrocinnamate, 3,5-bis(1,1-dimethylethyl)-4-hydroxybenzenepropanoic acid C7-C9-branched alkyl ester, 2,4-bis[(dodecylthio)methyl]-o-cresol, 4,4′-butylidene bis-(3-methyl-6-tert-butylphenol), 3,5-bis(1,1-dimethylethyl)-4-hydroxybenzenepropanoic acid octadecyl ester, pentaerythritol tetrakis(3-(3,5-di-tert-butyl-4-hydroxyphenyl)propionate), triethylene glycol bis[3-(3-tert-butyl-5-methyl-4-hydrophenyl)propionate], 2,4-bis(n-octylthio)-6-(4-hydroxy-3,5-di-tert-butylanilino)-1,3,5-triazine, tris-(3,5-di-tert-butyl-4-hydroxybenzyl) isocyanurate, 2,2-thiodiethylene bis[3-(3,5-di-tert-butyl-4-hydroxyphenyl)propionate].

The antioxidant, when present, may be in an amount of 0 to 2 wt. %, or about 0.01 to 1 wt. %, or about 0.2 to 0.8 wt. %, based on the total weight of the PBT composition.

The PBT composition may for example comprise an adhesive adjuvant. Suitable adhesive adjuvants may be epoxides, for example epoxidized alkyl esters of fatty acid such as epoxidized linseed oil, epoxidized soybean oil and epoxidized rapeseed oil, and epoxy resins such as bisphenol-A resin.

The adhesive adjuvant, when present, may be in an amount of 0 to 2 wt. %, or about 0.01 to 1 wt. %, or about 0.2 to 0.8 wt. %, based on the total weight of the PBT composition.

In a particular embodiment 1 according to the present invention, the PBT composition comprises:
(A) 10-90 wt. % of polybutylene terephthalate resin,
(B) 1-50 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 0-50 wt. % of glass fiber, and

(E) 0-15 wt. % of additives; based on the total weight of the PBT composition.

In one preferred embodiment 2, the PBT composition comprises:
(A) 20-80 wt. % of polybutylene terephthalate resin,
(B) 1-50 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 3, the PBT composition comprises:
(A) 20-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 4, the PBT composition comprises:
(A) 40-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 5, the PBT composition comprises:
(A) 20-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 6, the PBT composition comprises:
(A) 40-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 7, the PBT composition comprises:
(A) 40-80 wt. % of polybutylene terephthalate resin,
(B) 1-50 wt. % of amorphous polymer having a refractive index of at least 1.55, preferably 1.55-1.6, and having no carbonate group in the repeating units of the amorphous polymer,
(C) 0.01-5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 8, the PBT composition comprises:
(A) 20-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 9, the PBT composition comprises:
(A) 40-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 10, the PBT composition comprises:
(A) 20-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 11, the PBT composition comprises:
(A) 40-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 12, the PBT composition comprises:
(A) 20-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-2wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 13, the PBT composition comprises:
(A) 40-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-2wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 14, the PBT composition comprises:
(A) 40-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-2wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 15, the PBT composition comprises:
(A) 20-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.05-0.5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 16, the PBT composition comprises:
(A) 40-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.05-0.5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 17, the PBT composition comprises:
(A) 20-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.05-0.5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 18, the PBT composition comprises:
(A) 40-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.05-0.5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 19, the PBT composition comprises:
(A) 10-90 wt. % of polybutylene terephthalate resin,
(B) 1-50 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 20, the PBT composition comprises:
(A) 10-90 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 21, the PBT composition comprises:
(A) 20-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 22, the PBT composition comprises:
(A) 40-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 23, the PBT composition comprises:
(A) 20-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-5 wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 24, the PBT composition comprises:
(A) 40-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-5 wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 25, the PBT composition comprises:
(A) 20-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-5 wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 26, the PBT composition comprises:
(A) 40-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-5 wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 27, the PBT composition comprises:
(A) 20-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-2wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 28, the PBT composition comprises:
(A) 40-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-2wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 29, the PBT composition comprises:
(A) 20-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-2wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 30, the PBT composition comprises:
(A) 40-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-2wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 31, the PBT composition comprises:
(A) 40-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.05-0.5 wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 32, the PBT composition comprises:
(A) 40-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.05-0.5 wt. % of alkali metal carbonate and/or bicarbonate,
(D) 10-40 wt. % of glass fiber, preferably is E-glass fiber, and
(E) 0-15 wt. % of additives; based on the total weight of the PBT composition.

In another preferred embodiment 33, the PBT composition comprises:
(A) 10-90 wt. % of polybutylene terephthalate resin,
(B) 1-50 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition. In another preferred embodiment 34, the PBT composition comprises:
(A) 40-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition.

In another preferred embodiment 35, the PBT composition comprises:
(A) 20-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition.

In another preferred embodiment 36, the PBT composition comprises:
(A) 40-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-10 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition.

In another preferred embodiment 37, the PBT composition comprises:
(A) 40-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-5 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition.

In another preferred embodiment 38, the PBT composition comprises:
(A) 40-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer
(C) 0.01-5 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition.

In another preferred embodiment 39, the PBT composition comprises:
(A) 40-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.01-2 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition.

In another preferred embodiment 40, the PBT composition comprises:
(A) 20-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-2 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition.

In another preferred embodiment 41, the PBT composition comprises:
(A) 40-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.01-2 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition.

In another preferred embodiment 42, the PBT composition comprises:
(A) 20-80 wt. % of polybutylene terephthalate resin,
(B) 5-40 wt. % of amorphous polymer having a refractive index of at least 1.55, preferably 1.55-1.6, and having no carbonate group in the repeating units of the amorphous polymer,
(C) 0.05-0.5 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition.

In another preferred embodiment 43, the PBT composition comprises:
(A) 20-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.05-0.5 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition.

In another preferred embodiment 44, the PBT composition comprises:
(A) 40-80 wt. % of polybutylene terephthalate resin,
(B) 5-35 wt. % of amorphous polymer having a refractive index of at least 1.55, preferably 1.55-1.6, and having no carbonate group in the repeating units of the amorphous polymer,
(C) 0.05-0.5 wt. % of alkali metal carbonate and/or bicarbonate,
(D) 20-35 wt. % of glass fiber, preferably is E-glass fiber, and
(E) 0.01-15 wt. % of additives; based on the total weight of the PBT composition.

In another preferred embodiment 45, the PBT composition comprises:
(A) 10-90 wt. % of polybutylene terephthalate resin,
(B) 1-50 wt. % of amorphous polymer selected from the group consisting of polystyrene, styrene-acrylonitrile copolymer, amorphous copolyesters, and mixtures thereof,
(C) 0.01-10 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 46, the PBT composition comprises:
(A) 40-80 wt. % of polybutylene terephthalate resin,
(B) 5-40 wt. % of amorphous polymer selected from the group consisting of polystyrene, styrene-acrylonitrile copolymer, amorphous copolyesters, and mixtures thereof,
(C) 0.01-10 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 47, the PBT composition comprises:
(A) 40-80 wt. % of polybutylene terephthalate resin,
(B) 5-35 wt. % of amorphous polymer selected from the group consisting of polystyrene, styrene-acrylonitrile copolymer, amorphous copolyesters, and mixtures thereof,
(C) 0.01-10 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 48, the PBT composition comprises:
(A) 40-80 wt. % of polybutylene terephthalate resin,
(B) 5-40 wt. % of amorphous polymer selected from the group consisting of polystyrene, styrene-acrylonitrile copolymer, amorphous copolyesters, and mixtures thereof,
(C) 0.01-5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 49, the PBT composition comprises:
(A) 40-80 wt. % of polybutylene terephthalate resin,
(B) 5-35 wt. % of amorphous polymer selected from the group consisting of polystyrene, styrene-acrylonitrile copolymer, amorphous copolyesters, and mixtures thereof,
(C) 0.01-5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 50, the PBT composition comprises:
(A) 40-80 wt. % of polybutylene terephthalate resin,
(B) 5-40 wt. % of amorphous polymer selected from the group consisting of polystyrene, styrene-acrylonitrile copolymer, amorphous copolyesters, and mixtures thereof,
(C) 0.01-2 wt. % or 0.05-0.5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 51, the PBT composition comprises:
(A) 40-80 wt. % of polybutylene terephthalate resin,
(B) 1-50 wt. % of amorphous polymer selected from the group consisting of polystyrene, styrene-acrylonitrile copolymer, amorphous copolyesters, and mixtures thereof,
(C) 0.01-10 wt. % of alkali metal carbonate and/or bicarbonate,
(D) 10-40 wt. % of glass fiber, preferably is E-glass fiber, and
(E) 0.01-15 wt. % of additives; based on the total weight of the PBT composition.

In another preferred embodiment 52, the PBT composition comprises:
(A) 40-80 wt. % of polybutylene terephthalate resin,
(B) 5-40 wt. % of amorphous polymer selected from the group consisting of polystyrene, styrene-acrylonitrile copolymer, amorphous copolyesters, and mixtures thereof,
(C) 0.01-10 wt. % of alkali metal carbonate and/or bicarbonate,
(D) 10-40 wt. % of glass fiber, preferably is E-glass fiber, and
(E) 0.01-15 wt. % of additives; based on the total weight of the PBT composition.

In another preferred embodiment 53, the PBT composition comprises:
(A) 40-80 wt. % of polybutylene terephthalate resin,
(B) 5-40 wt. % of amorphous polymer selected from the group consisting of polystyrene, styrene-acrylonitrile copolymer, amorphous copolyesters, and mixtures thereof,
(C) 0.01-5 wt. % of alkali metal carbonate and/or bicarbonate,
(D) 10-40 wt. % of glass fiber, preferably is E-glass fiber, and
(E) 0.01-15 wt. % of additives; based on the total weight of the PBT composition.

In another preferred embodiment 54, the PBT composition comprises:
(A) 40-80 wt. % of polybutylene terephthalate resin,
(B) 5-35 wt. % of amorphous polymer selected from the group consisting of polystyrene, styrene-acrylonitrile copolymer, amorphous copolyesters, and mixtures thereof,
(C) 0.01-5 wt. % of alkali metal carbonate and/or bicarbonate,
(D) 10-40 wt. % of glass fiber, preferably is E-glass fiber, and
(E) 0.01-15 wt. % of additives; based on the total weight of the PBT composition.

In another preferred embodiment 55, the PBT composition comprises:
(A) 40-80 wt. % of polybutylene terephthalate resin,
(B) 5-40 wt. % of amorphous polymer selected from the group consisting of polystyrene, styrene-acrylonitrile copolymer, amorphous copolyesters, and mixtures thereof,
(C) 0.01-2 wt. % or 0.05-0.5 wt. % of alkali metal carbonate and/or bicarbonate,
(D) 10-40 wt. % of glass fiber, preferably is E-glass fiber, and
(E) 0.01-15 wt. % of additives; based on the total weight of the PBT composition.

In another preferred embodiment 56, the PBT composition comprises:
(A) 40-80 wt. % of polybutylene terephthalate resin,
(B) 5-35 wt. % of amorphous polymer selected from the group consisting of polystyrene, styrene-acrylonitrile copolymer, amorphous copolyesters, and mixtures thereof,
(C) 0.01-2 wt. % or 0.05-0.5 wt. % of alkali metal carbonate and/or bicarbonate,
(D) 10-40 wt. % of glass fiber, preferably is E-glass fiber, and
(E) 0.01-15 wt. % of additives; based on the total weight of the PBT composition.

In another preferred embodiment 57, the PBT composition comprises:
(A) 40-80 wt. % of polybutylene terephthalate resin,
(B) 5-40 wt. % of amorphous polymer selected from the group consisting of polystyrene, styrene-acrylonitrile copolymer, amorphous copolyesters, and mixtures thereof, polystyrene is derived from Formula I which is selected from the group consisting of styrene, alpha-methylstyrene, 2-methylstyrene, 3-methylstyrene, 4-methylstyrene, 2,4-dimethylstyrene, 2,5-dimethylstyrene, para-alpha-dimethylstyrene, 2-ethylstyrene, 3-ethylstyrene, 4-ethyl styrene, 2-isopropyl styrene, 3-isopropyl styrene, 4-isopropyl styrene, ortho-divinylbenzene, meta-divinylbenzene, para-divinylbenzene, ethoxy styrene, chlorostyrene, bromostyrene, dibromostyrene, dichlorostyrene, tribromostyrene, trichlorostyrene, 2-vinylnaphthalene and 2-isopropenylnaphthalene; styrene-acrylonitrile copolymer is selected from the group consisting of styrene/acrylonitrile copolymers, α-methylstyrene/acrylonitrile copolymers, styrene acrylonitrile-maleic anhydride copolymers, styrene-acrylonitrile-phenylmaleimide copolymers, α-methylstyrene-acrylonitrile-methyl methacrylate copolymers, α-methyl-styrene-acrylonitrile-t-butylmethacrylate copolymers, and styrene-acrylonitrile-t-butylmethacrylate copolymers, the amorphous copolyester is cyclohexanedimethylene modified poly (ethylene terephthalate), ethylene modified poly(1,4-cyclohexanedimethylene terephthalate) or the mixture thereof,
(C) 0.01-5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 58, the PBT composition comprises:
(A) 40-80 wt. % of polybutylene terephthalate resin,
(B) 5-35 wt. % of amorphous polymer selected from the group consisting of polystyrene, styrene-acrylonitrile copolymer, amorphous copolyesters, and mixtures thereof, polystyrene is derived from Formula I which is selected from the group consisting of styrene, alpha-methylstyrene, 2-methylstyrene, 3-methylstyrene, 4-methylstyrene, 2,4-dimethylstyrene, 2,5-dimethylstyrene, para-alpha-dimethylstyrene, 2-ethylstyrene, 3-ethylstyrene, 4-ethyl styrene, 2-isopropyl styrene, 3-isopropyl styrene, 4-isopropyl styrene, ortho-divinylbenzene, meta-divinylbenzene, para-divinylbenzene, ethoxy styrene, chlorostyrene, bromostyrene, dibromostyrene, dichlorostyrene, tribromostyrene, trichlorostyrene, 2-vinylnaphthalene and 2-isopropenylnaphthalene; styrene-acrylonitrile copolymer is selected from the group consisting of styrene/acrylonitrile copolymers, α-methylstyrene/acrylonitrile copolymers, styrene acrylonitrile-maleic anhydride copolymers, styrene-acrylonitrile-phenylmaleimide copolymers, α-methylstyrene-acrylonitrile-methyl methacrylate copolymers, α-methyl-styrene-acrylonitrile-t-butylmethacrylate copolymers, and styrene-acrylonitrile-t-butylmethacrylate copolymers, the amorphous copolyester is cyclohexanedimethylene modified poly(ethylene terephthalate), ethylene modified poly(1,4-cyclohexanedimethylene terephthalate) or the mixture thereof,
(C) 0.01-5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 59, the PBT composition comprises:
(A) 40-80 wt. % of polybutylene terephthalate resin,
(B) 5-40 wt. % of amorphous polymer selected from the group consisting of polystyrene, styrene-acrylonitrile copolymer, amorphous copolyesters, and mixtures thereof, polystyrene is derived from Formula I which is selected from the group consisting of styrene, alpha-methylstyrene, 2-methylstyrene, 3-methylstyrene, 4-methylstyrene, 2,4-dimethylstyrene, 2,5-dimethylstyrene, para-alpha-dimethylstyrene, 2-ethylstyrene, 3-ethylstyrene, 4-ethyl styrene, 2-isopropyl styrene, 3-isopropyl styrene, 4-isopropyl styrene, ortho-divinylbenzene, meta-divinylbenzene, para-divinylbenzene, ethoxy styrene, chlorostyrene, bromostyrene, dibromostyrene, dichlorostyrene, tribromostyrene, trichlorostyrene, 2-vinylnaphthalene and 2-isopropenylnaphthalene; styrene-acrylonitrile copolymer is selected from the group consisting of styrene/acrylonitrile copolymers, α-methylstyrene/acrylonitrile copolymers, styrene acrylonitrile-maleic anhydride copolymers, styrene-acrylonitrile-phenylmaleimide copolymers, α-methylstyrene-acrylonitrile-methyl methacrylate copolymers, α-methyl-styrene-acrylonitrile-t-butylmethacrylate copolymers, and styrene-acrylonitrile-t-butylmethacrylate copolymers, the amorphous copolyester is cyclohexanedimethylene modified poly (ethylene terephthalate), ethylene modified poly(1,4-cyclohexanedimethylene terephthalate) or the mixture thereof,
(C) 0.01-2 wt. % or 0.05-0.5 wt. % of alkali metal carbonate and/or bicarbonate,
(D) 0-50 wt. % of glass fiber, preferably is E-glass fiber, and
(E) 0-15 wt. % of additives; based on the total weight of the PBT composition.

In another preferred embodiment 60, the PBT composition comprises:
(A) 40-80 wt. % of polybutylene terephthalate resin,
(B) 5-40 wt. % of amorphous polymer selected from the group consisting of polystyrene, styrene-acrylonitrile copolymer, amorphous copolyesters, and mixtures thereof, polystyrene is derived from Formula I which is selected from the group consisting of styrene, alpha-methylstyrene, 2-methylstyrene, 3-methylstyrene, 4-methylstyrene, 2,4-dimethylstyrene, 2,5-dimethylstyrene, para-alpha-dimethylstyrene, 2-ethylstyrene, 3-ethylstyrene, 4-ethyl styrene, 2-isopropyl styrene, 3-isopropyl styrene, 4-isopropyl styrene, ortho-divinylbenzene, meta-divinylbenzene, para-divinylbenzene, ethoxy styrene, chlorostyrene, bromostyrene, dibromostyrene, dichlorostyrene, tribromostyrene, trichlorostyrene, 2-vinylnaphthalene and 2-isopropenylnaphthalene; styrene-acrylonitrile copolymer is selected from the group consisting of styrene/acrylonitrile copolymers, α-methylstyrene/acrylonitrile copolymers, styrene acrylonitrile-maleic anhydride copolymers, styrene-acrylonitrile-phenylmaleimide copolymers, α-methylstyrene-acrylonitrile-methyl methacrylate copolymers, α-methyl-styrene-acrylonitrile-t-butylmethacrylate copolymers, and styrene-acrylonitrile-t-butylmethacrylate copolymers, the amorphous copolyester is cyclohexanedimethylene modified poly(ethylene terephthalate), ethylene modified poly(1,4-cyclohexanedimethylene terephthalate) or the mixture thereof,
(C) 0.01-5 wt. % of alkali metal carbonate and/or bicarbonate,
(D) 10-40 wt. % of glass fiber, preferably is E-glass fiber, and
(E) 0.01-15 wt. % of additives; based on the total weight of the PBT composition.

In another preferred embodiment 61, the PBT composition comprises:
(A) 40-80 wt. % of polybutylene terephthalate resin,
(B) 5-35 wt. % of amorphous polymer selected from the group consisting of polystyrene, styrene-acrylonitrile copolymer, amorphous copolyesters, and mixtures thereof, polystyrene is derived from Formula I which is selected from the group consisting of styrene, alpha-methylstyrene, 2-methylstyrene, 3-methylstyrene, 4-methylstyrene, 2,4-dimethylstyrene, 2,5-dimethylstyrene, para-alpha-dimethylstyrene, 2-ethylstyrene, 3-ethylstyrene, 4-ethyl styrene, 2-isopropyl styrene, 3-isopropyl styrene, 4-isopropyl styrene, ortho-divinylbenzene, meta-divinylbenzene, para-divinylbenzene, ethoxy styrene, chlorostyrene, bromostyrene, dibromostyrene, dichlorostyrene, tribromostyrene, trichlorostyrene, 2-vinylnaphthalene and 2-isopropenylnaphthalene; styrene-acrylonitrile copolymer is selected from the group consisting of styrene/acrylonitrile copolymers, α-methylstyrene/acrylonitrile copolymers, styrene acrylonitrile-maleic anhydride copolymers, styrene-acrylonitrile-phenylmaleimide copolymers, α-methylstyrene-acrylonitrile-methyl methacrylate copolymers, α-methyl-styrene-acrylonitrile-t-butylmethacrylate copolymers, and styrene-acrylonitrile-t-butylmethacrylate copolymers, the amorphous copolyester is cyclohexanedimethylene modified poly (ethylene terephthalate), ethylene modified poly(1,4-cyclohexanedimethylene terephthalate) or the mixture thereof,
(C) 0.01-5 wt. % of alkali metal carbonate and/or bicarbonate,
(D) 10-40 wt. % of glass fiber, preferably is E-glass fiber, and
(E) 0.01-15 wt. % of additives; based on the total weight of the PBT composition.

In another preferred embodiment 62, the PBT composition comprises:
(A) 20-80 wt. % of polybutylene terephthalate resin,
(B) 5-40 wt. % of amorphous polymer selected from the group consisting of polystyrene, styrene-acrylonitrile copolymer, amorphous copolyesters, and mixtures thereof, polystyrene is derived from Formula I which is selected from the group consisting of styrene, alpha-methylstyrene, 2-methylstyrene, 3-methylstyrene, 4-methylstyrene, 2,4-dimethylstyrene, 2,5-dimethylstyrene, para-alpha-dimethylstyrene, 2-ethylstyrene, 3-ethylstyrene, 4-ethyl styrene, 2-isopropyl styrene, 3-isopropyl styrene, 4-isopropyl styrene, ortho-divinylbenzene, meta-divinylbenzene, para-divinylbenzene, ethoxy styrene, chlorostyrene, bromostyrene, dibromostyrene, dichlorostyrene, tribromostyrene, trichlorostyrene, 2-vinylnaphthalene and 2-isopropenylnaphthalene; styrene-acrylonitrile copolymer is selected from the group consisting of styrene/acrylonitrile copolymers, α-methylstyrene/acrylonitrile copolymers, styrene acrylonitrile-maleic anhydride copolymers, styrene-acrylonitrile-phenylmaleimide copolymers, α-methylstyrene-acrylonitrile-methyl methacrylate copolymers, α-methyl-styrene-acrylonitrile-t-butylmethacrylate copolymers, and styrene-acrylonitrile-t-butylmethacrylate copolymers, the amorphous copolyester is cyclohexanedimethylene modified poly(ethylene terephthalate), ethylene modified poly(1,4-cyclohexanedimethylene terephthalate) or the mixture thereof,
(C) 0.01-2 wt. % or 0.05-0.5 wt. % of alkali metal carbonate and/or bicarbonate,
(D) 10-40 wt. % of glass fiber, preferably is E-glass fiber, and
(E) 0.01-15 wt. % of additives; based on the total weight of the PBT composition.

In another preferred embodiment 63, the PBT composition comprises:
(A) 40-80 wt. % of polybutylene terephthalate resin,
(B) 5-40 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-5 wt. % of sodium or potassium carbonate, and/or sodium or potassium bicarbonate,
(D) 0-50 wt. % of glass fiber, preferably is E-glass fiber, and
(E) 0-15 wt. % of additives; based on the total weight of the PBT composition.

In another preferred embodiment 64, the PBT composition comprises:
(A) 40-80 wt. % of polybutylene terephthalate resin,
(B) 5-35 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-5 wt. % of sodium or potassium carbonate, and/or sodium or potassium bicarbonate,
(D) 0-50 wt. % of glass fiber, preferably is E-glass fiber, and
(E) 0-15 wt. % of additives; based on the total weight of the PBT composition.

In another preferred embodiment 65, the PBT composition comprises:
(A) 40-80 wt. % of polybutylene terephthalate resin,
(B) 5-40 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-2 wt. % or 0.05-0.5 wt. % of sodium or potassium carbonate, and/or sodium or potassium bicarbonate,
(D) 0-50 wt. % of glass fiber, preferably is E-glass fiber, and
(E) 0-15 wt. % of additives; based on the total weight of the PBT composition.

In another preferred embodiment 66, the PBT composition comprises:
(A) 40-80 wt. % of polybutylene terephthalate resin,
(B) 5-35 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-2 wt. % or 0.05-0.5 wt. % of sodium or potassium carbonate, and/or sodium or potassium bicarbonate,
(D) 0-50 wt. % of glass fiber, preferably is E-glass fiber, and
(E) 0-15 wt. % of additives; based on the total weight of the PBT composition.

In another preferred embodiment 67, the PBT composition comprises:
(A) 40-80 wt. % of polybutylene terephthalate resin,
(B) 5-35 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-5 wt. % of sodium or potassium carbonate, and/or sodium or potassium bicarbonate,
(D) 10-40 wt. % of glass fiber, preferably is E-glass fiber, and
(E) 0.01-15 wt. % of additives; based on the total weight of the PBT composition.

In another preferred embodiment 68, the PBT composition comprises:
(A) 10-90 wt. % of polybutylene terephthalate resin,
(B) 1-50 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-2 wt. % or 0.05-0.5 wt. % of sodium or potassium carbonate, and/or sodium or potassium bicarbonate,
(D) 10-40 wt. % of glass fiber, preferably is E-glass fiber, and
(E) 0.01-15 wt. % of additives; based on the total weight of the PBT composition.

In another preferred embodiment 69, the PBT composition comprises:
(A) 40-80 wt. % of polybutylene terephthalate resin,
(B) 5-40 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-5 wt. % of sodium or potassium carbonate, and/or sodium or potassium bicarbonate,
(D) 0-50 wt. % of glass fiber, preferably is E-glass fiber, and
(E) 0.01-15 wt. % of additives comprising 0.01 to 3 wt. % of lubricant; based on the total weight of the PBT composition.

In another preferred embodiment 70, the PBT composition comprises:
(A) 40-80 wt. % of polybutylene terephthalate resin,
(B) 5-35 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-2 wt. % or 0.05-0.5 wt. % of sodium or potassium carbonate, and/or sodium or potassium bicarbonate,
(D) 0-50 wt. % of E-glass fiber, and
(E) 0-15 wt. % of additives comprising 0.01 to 3 wt. % of lubricant; based on the total weight of the PBT composition.

In another preferred embodiment 71, the PBT composition comprises:
(A) 40-80 wt. % of polybutylene terephthalate resin,
(B) 5-40 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-5 wt. % of sodium or potassium carbonate, and/or sodium or potassium bicarbonate,
(D) 10-40 wt. % of E-glass fiber, and
(E) 0.01-15 wt. % of additives comprising 0.01 to 3 wt. % of lubricant; based on the total weight of the PBT composition.

In another preferred embodiment 72, the PBT composition comprises:
(A) 40-80 wt. % of polybutylene terephthalate resin,
(B) 5-35 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-5 wt. % of sodium or potassium carbonate, and/or sodium or potassium bicarbonate,
(D) 10-40 wt. % of E-glass fiber, and
(E) 0.01-15 wt. % of additives comprising 0.01 to 3 wt. % of lubricant; based on the total weight of the PBT composition.

In another preferred embodiment 73, the PBT composition comprises:
(A) 20-80 wt. % of polybutylene terephthalate resin,
(B) 5-40 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-2 wt. % or 0.05-0.5 wt. % of sodium or potassium carbonate, and/or sodium or potassium bicarbonate,
(D) 10-40 wt. % of E-glass fiber, and
(E) 0.01-15 wt. % of additives comprising 0.01 to 3 wt. % of lubricant; based on the total weight of the PBT composition.

In another preferred embodiment 74, the PBT composition comprises:
(A) 40-80 wt. % of polybutylene terephthalate resin,
(B) 5-35 wt. % of amorphous polymer selected from the group consisting of polystyrene, poly methylstyrene, styrene/acrylonitrile copolymers, α-methylstyrene/acrylonitrile copolymers, styrene acrylonitrile-maleic anhydride copolymers, PETG and PCTG,
(C) 0.01-2 wt. % or 0.05-0.5 wt. % of sodium or potassium carbonate, and/or sodium or potassium bicarbonate,
(D) 10-40 wt. % of E-glass fiber, and
(E) 0.01-15 wt. % of additives comprising 0.01 to 3 wt. % of lubricant; based on the total weight of the PBT composition.

The PBT composition according to the present invention can be processed into various structures or forms by conventional methods to provide articles having improved laser transmittance. For example, all components of the PBT composition according to the present invention can be mixed and then molded, for example via injection and/or extrusion in conventional mixing apparatus, such as screw extruders, mixers to form the articles. The mixing temperatures used herein are generally from 220° C. to 260° C.

It will be understood that all components of the PBT composition can be mixed at the same time. Alternatively, some components of the PBT composition can be pre-mixed and then mixed with other components. For example, all components of the PBT composition except glass fibers are mixed together in a stirrer and fed into a twin-screw extruder at the throat, then the glass fibers are fed at downstream using a side feeder.

Accordingly, the present invention provides an article produced from the PBT composition according to the present invention.

Articles according to the present invention have a laser transmission for 2 mm specimen at 1064 nm of more than 30%.

Thus, the articles produced from the PBT composition according to the present invention can be used in many fields, including but being not limited to, automobile, electrical, mechanical engineering, other means of transport, housing material for equipment, apparatuses for telecommunications, consumer electronics, household devices, fastening parts for installation work, containers, or ventilation parts of any type.

Possible articles produced from the PBT composition according to the present invention could be sensor, electric control unit or advanced driver assistance system (ADAS) device for automobile application, etc.

The present invention also provides an application of alkali metal carbonate and/or bicarbonate in improving laser transmittance of polybutylene terephthalate composition. It's preferably that the polybutylene terephthalate composition comprising amorphous polymer having a refractive index of at least 1.55 and having no carbonate group in the repeating units of the amorphous polymer.

### EMBODIMENTS

Various embodiments are listed below. It will be understood that the embodiments listed below can be combined with all aspects and other embodiments in accordance with the scope of the invention.

1. A polybutylene terephthalate composition, comprising:
(A) polybutylene terephthalate resin,
(B) amorphous polymer having a refractive index of at least 1.55 and having no carbonate group in the repeating units of the amorphous polymer,
(C) alkali metal carbonate and/or bicarbonate,
(D) optionally glass fiber, and
(E) optionally additives.

2. The polybutylene terephthalate composition according to embodiment 1, wherein the amorphous polymer (B) has a refractive index of from 1.55 to 1.60.

3. The polybutylene terephthalate composition according to embodiment 1 or 2, wherein the amorphous polymer is selected from the group consisting of polystyrene, styrene-acrylonitrile copolymer, amorphous copolyesters, and mixtures thereof.

4. The polybutylene terephthalate composition according to any preceding embodiments, wherein
the polystyrene comprises units derived from 50 mol % to 100 mol %, preferably from 60 mol % to 99.5 mol %, most preferably from 70 mol % to 99.5 mol % of at least one monomer having the Formula I, based on the total units of polystyrene:

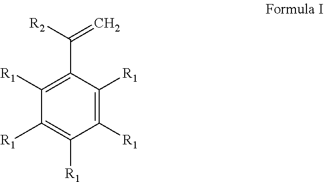

wherein R₁ is same or different and is selected from the group consisting of hydrogen, C₁-C₁₀ alkyl group, C₁-C₆ alkenyl group, C₄-C₁₀ cycloaliphatic group, C₆-C₁₂ aromatic hydrocarbon group, C₁-C₄ alkoxy group and halogen atoms; R₂ is hydrogen and/or C₁-C₄ alkyl group;
styrene-acrylonitrile copolymer comprise:
   (B.1) 50 to 99 parts by mass of vinyl aromatic monomer and/or ring-substituted vinyl aromatic monomer,
   (B.2) 1 to 50 parts by mass of vinyl cyanide monomer
   and optionally (B.3) C₁-C₈ alkyl methacrylate, based on the total parts by mass of monomers of styrene-acrylonitrile copolymer; or
amorphous copolyester having at least two different repeating units RP₁ and RP₂ in a combined amount of at least 55 mol %, preferably at least 80 mol %, more preferably at least 90 mol %, based on the total repeating units of the copolyester;
wherein the repeating unit RP₁ is derived from glycol and dicarboxylic acid, the dicarboxylic acid includes terephthalic acid and optionally other dicarboxylic acid, the repeating unit RP₂ is derived from glycol and dicarboxylic acid; the mole ratio of the glycol in the RP₁ to the glycol in the RP₂ is from 2:8 to 8:2.

5. The polybutylene terephthalate composition according to any preceding embodiments, wherein
Formula I is selected from the group consisting of styrene, alpha-methylstyrene, 2-methylstyrene, 3-methylstyrene, 4-methylstyrene, 2,4-dimethylstyrene, 2,5-dimethylstyrene, para-alpha-dimethylstyrene, 2-ethylstyrene, 3-ethylstyrene, 4-ethyl styrene, 2-isopropyl styrene, 3-isopropyl styrene, 4-isopropyl styrene, ortho-divinylbenzene, meta-divinylbenzene, para-divinylbenzene, ethoxy styrene, chlorostyrene, bromostyrene, dibromostyrene, dichlorostyrene, tribromostyrene, trichlorostyrene, 2-vinylnaphthalene and 2-isopropenylnaphthalene,
styrene-acrylonitrile copolymer is selected from the group consisting of styrene/acrylonitrile copolymers, α-methylstyrene/acrylonitrile copolymers, styrene acrylonitrile-maleic anhydride copolymers, styrene-acrylonitrile-phenylmaleimide copolymers, α-methylstyrene-acrylonitrile-methyl methacrylate copolymers, α-methyl-styrene-acrylonitrile-t-butylmethacrylate copolymers, and styrene-acrylonitrile-t-butylmethacrylate copolymers.
the amorphous copolyester is cyclohexanedimethylene modified poly(ethylene terephthalate), ethylene modified poly(1,4-cyclohexanedimethylene terephthalate) and the mixture thereof.

6. The polybutylene terephthalate composition according to any preceding embodiments, wherein alkali metal carbonate and/or bicarbonate (C) is selected from the group consisting of sodium carbonate, sodium bicarbonate, potassium carbonate and potassium bicarbonate.

7. The polybutylene terephthalate composition according to any preceding embodiments, wherein the polybutylene terephthalate resin (A) is in an amount of from 10 wt. % to 90 wt. %, preferably from 20 wt. % to 80 wt. %, more preferably from 40 wt. % to 80 wt. %, based on the total weight of the polybutylene terephthalate composition.

8. The polybutylene terephthalate composition according to any preceding embodiments, wherein the amorphous polymer (B) is in an amount of from 1 wt. % to 50 wt. %, preferably from 5 wt. % to 40 wt. %, more preferably from 5 wt. % to 35 wt. %, based on the total weight of the PBT composition.

9. The polybutylene terephthalate composition according to any preceding embodiments, wherein the alkali metal carbonate and/or bicarbonate (C) is in an amount of from 0.01 wt. % to 10 wt. %, preferably from 0.01 wt. % to 5 wt. %, more preferably from 0.01 wt. % to 2 wt. %, most preferably from 0.05 wt. % to 0.5 wt. %, based on the total weight of the PBT composition.

10. The polybutylene terephthalate composition according to any preceding embodiments, wherein the glass fiber (D) is in an amount of from 0 wt. % to 50 wt. %, preferably from 10 wt. % to 40 wt. %, more preferably from 20 wt. % to 35 wt. %, based on the total weight of the polybutylene terephthalate composition.

11. The polybutylene terephthalate composition according to any preceding claims, wherein the glass fiber (D) is E-glass fiber and/or D-glass fiber.

12. The polybutylene terephthalate composition according to any preceding embodiments, wherein the additives (E) are in an amount of 0.01-15 wt. %, based on the total weight of the polybutylene terephthalate composition.

13. An article produced from the polybutylene terephthalate composition according to any of embodiments 1-12.

14. The article according to embodiment 13, wherein the article is sensor, electric control unit or advanced driver assistance system device for automobile.

15. An application of alkali metal carbonate and/or bicarbonate in improving laser transmittance of polybutylene terephthalate composition.

16. The application according to embodiment 15, the polybutylene terephthalate composition is the one according to any of embodiment s 1-12.

### EXAMPLES

The disclosure of the invention as found herein is to be considered to cover all embodiments as found in the claims as being multiply dependent upon each other irrespective of the fact that claims may be found without multiple dependency or redundancy.

The following examples are provided to facilitate an understanding of the invention. The examples are not intended to limit the scope of the claims.

### Materials

PBT base resin: PBT 1100-211MB, Ultradur B4500, Ultradur B2550 from BASF
Lubricant or processing agent: LOXIOL P 861/3.5 from IMCD Deutschland Gmbh & Co. KG
PS: PS POLYREX® PG-383M from CHIMEI, refractive index is 1.59
PETG: PETG S2008 from SK chemical, refractive index is 1.55
SAN: SAN Chimei PN-128L100 from CHIMEI, refractive index is 1.57
Polypropylene: PP F401 from Sinopec Yangzi Petrochemical, refractive index is 1.47
PMMA: PMMA ACRYREX® CM-211 from CHIMEI, refractive index is 1.48
COC: Cycloolefin Copolymers from Polyplastics, refractive index is 1.53
E-Glass Fiber, round: PBT-NEG-T187H from Nippon Electric Glass
E-Glass Fiber, flat glass fiber: CSG3PA820 from Nittobo
D-Glass fiber (D-GF): ECS303(HL)303N-3 from Chongqing Polycomp
Antioxidant: Irganox 1010 from BASF
Refractive index is determined at 25° C. and wavelength of 589 nm according to ASTM D542.

In accordance with the invention, the following testing methods are adopted in the measurements of the properties in all examples:

### Measurements

Laser transmittance
BASF method: adopting infrared laser at a wavelength of 1064 nm, laser type: Nd: YAG; the laser transmittance is measured using a specimen with a thickness (plate) of 2 mm.

A thermoelectric power measurement was used to determine laser transmittance at wavelength 1064 nm. The measurement geometry was set up as follows:
A beam splitter (SQ2 nonpolarizing beam splitter from Laseroptik GmbH) was used to divide a reference beam of power 1 Watt at an angle of 90ngle of 90ider beam (diode-pumped Nd-YAG laser of wavelength 1064 nm, FOBA DP50) with total power of 2 Watts. The reference beam impacted the reference sensor. That portion of the original beam that passed through the beam splitter provided the measurement beam likewise with power of 1 Watt. This measurement beam was focused to a focus with diameter of 0.18 μm via a mode diaphragm (5.0) which is behind the beam splitter. The laser transmittance (LT) measurement sensor was positioned 80 mm below the focus. The test sheet was positioned 2 mm above the LT measurement sensor. The total measurement time was 30 s, the measurement result being determined within the final 5 s. The signals from reference sensor and measurement sensor were captured simultaneously. The start of the measurement was simultaneous with the insertion of the sample.

Laser transmittance was obtained from the following formula:

$$Laser transmittance \frac{Signal 1}{Signal 2} \times 100 \% =$$

Signal 1 is the signal captured by the measurement sensor; Signal 2 is the signal captured by the reference sensor. This method of measurement excluded variations of the laser system and subjective reading errors.

LPKF method: adopting infrared laser at a wavelength of 980 nm, the laser transmittance is measured using a specimen with a thickness (plate) of 1.4 mm by LPKF TMG 3, inline- or stand-alone-transmission test system.

Tensile modulus (MPa), tensile strength at break (MPa) and Elongation at break (%) were measured particularly according to ISO 527-1-2012. Test specimens of type 1A described in ISO 527-1-2012 were used.

Charpy notched impact strength was tested according to ISO 179-1-2010 via edgewise impact. The test specimens are type 1 with notched type A.

Melt Flow Test was conducted according to ISO 1133 under a condition of 250° C., 2.16 kg or 275° C., 5 kg.

Thermal Properties were obtained according to ISO 75-1/-2; including HDT A under 1.80 MPa and HDT B under 0.45 MPa.

Dk/2 GHz and Df/2 GHz: Dk and Df under 2 GHz were tested according to GB/T 12636-90, and Dk and Df under 2.5 GHz were tested according to IEC 60250.

### Manufacturing of the PBT Composition

ZSK18 Twin-screw extruder, commercially available from Coperion, was used in all manufacturing of PBT composition; in which compounding conditions included: barrel temperature for zones 1-4 were kept at 250° C., zones 5-6 at 255° C., screw speed was 300 rmp and throughput was 7 kg/hour.

At the beginning of the process, all components were weighted in a high-speed mixer to obtain a pre-mix, and then the obtained pre-mix was fed into the extruder through a hopper.

The dried pellets of the PBT composition were processed in an injection molding machine (KM130CX, from Krauss Maffei) with a clamping force of 130 T at melt temperatures of 220° C. to 260° C. to provide a test specimen.

The obtained test specimens were measured for the properties as described above. The test results and the formulations for the preparation of the test specimens are summarized in Tables 1-6.
Comp. is Comparative example
Exp. is Example

TABLE 1

| Component by wt. % | Comp. 1 | Comp. 2 | Comp. 3 | Exp. 1 | Exp. 2 | Comp. 4 | Comp. 5 |
|---|---|---|---|---|---|---|---|
| PBT 1100-211MB | 69.545 | 49.545 | 69.395 | 49.395 | 54.395 | 69.395 | 69.245 |
| PS POLYREX ® PG-383M | — | 20 | — | 20 | 15 | — | — |
| PBT-NEG-T187H | 30 | 30 | 30 | 30 | 30 | 30 | 30 |
| Sodium carbonate | — | — | 0.15 | 0.15 | 0.15 | — | — |
| NaHCO₃ | — | — | — | — | — | 0.15 | — |
| K₂CO₃ | — | — | — | — | — | — | 0.3 |
| LOXIOL P 861/3.5 | 0.455 | 0.455 | 0.455 | 0.455 | 0.455 | 0.455 | 0.455 |
| Total percentage | 100 | 100 | 100 | 100 | 100 | 100 | 100 |
| Laser Transmittance, @1064 nm, % | 22.3 | 29.21 | 38.5 | 60.773 | 55.5 | 32.4 | 41.3 |
| Tensile modulus, MPa | 1.01E+04 | 1.06E+04 | 1.01E+04 | 1.09E+04 | 1.09E+04 | 1.01E+04 | 1.01E+04 |
| Elongation at break, % | 3.1 | 1.9 | 3.2 | 1.7 | 2.0 | 3.0 | 3.2 |
| Tensile strength at break, MPa | 145 | 133 | 145 | 136 | 146 | 141 | 146 |
| Charpy, Notched at 23° C., KJ/m² | 9.6 | 9.4 | 9.7 | 9.1 | 8.4 | 9.2 | 9.3 |
| MVR (250° C., 2.16 kg), cc/10 min | 8.49 | 5.31 | 3.73 | 3.14 | 3.47 | 7.0 | 6.8 |
| HDT A (1.80 MPa), ° C. | 205 | 179 | 207 | 195 | 198 | 208 | 208 |
| HDT B (0.45 MPa), ° C. | 220 | 214 | 220 | 216 | 218 | 221 | 221 |
| Dk/2 GHz | 3.52 | 3.31 | 3.51 | 3.30 | 3.37 | — | — |
| Df/2 GHz | 0.01 | 0.007 | 0.01 | 0.007 | 0.008 | — | — |

TABLE 2

| Component by wt. % | Comp. 1 | Comp. 6 | Comp. 7 | Exp. 3 | Comp. 8 | Exp. 4 | Exp. 5 |
|---|---|---|---|---|---|---|---|
| PBT 1100-211MB | 69.545 | 49.545 | 69.425 | 49.425 | 59.545 | 54.425 | 54.395 |
| PETG S2008 | — | 20 | — | 20 | 10 | 15 | 15 |
| PBT-NEG-T187H | 30 | 30 | 30 | 30 | 30 | 30 | 30 |
| Sodium carbonate | — | — | 0.12 | 0.12 | — | 0.12 | 0.15 |
| LOXIOL P 861/3.5 | 0.455 | 0.455 | 0.455 | 0.455 | 0.455 | 0.455 | 0.455 |
| Total percentage | 100 | 100 | 100 | 100 | 100 | 100 | 100 |
| Laser Transmittance, @1064 nm, % | 22.3 | 32.5 | 35.2 | 43.6 | 27.6 | 34.3 | 41.4 |
| Tensile modulus, MPa | 1.01E+04 | 1.00E+04 | 1.02E+04 | 1.03E+04 | 1.01E+04 | 1.04E+04 | 1.04E+04 |
| Elongation at break, % | 3.1 | 3.1 | 3.3 | 2.9 | 3.2 | 2.8 | 3.1 |
| Tensile strength at break, MPa | 145 | 142 | 149 | 146 | 144 | 145 | 145 |
| Charpy, Notched at 23° C., KJ/m² | 9.6 | 9.2 | 9.6 | 8.7 | 10 | 8.8 | 9.6 |
| MVR (250° C., 2.16 kg), cc/10 min | 8.49 | 7.16 | 5.27 | 6.03 | 8.18 | 7.17 | 6.00 |
| HDT A (1.80 MPa), ° C. | 205 | 163 | 209 | 179 | 192 | 192 | 191 |
| HDT B (0.45 MPa), ° C. | 220 | 212 | 219 | 209 | — | 215 | 214 |

TABLE 3

| Component by wt. % | Comp. 1 | Comp. 9 | Exp. 6 |
|---|---|---|---|
| PBT 1100-211MB | 69.545 | 49.545 | 49.395 |
| SAN Chimei PN-128L100 | — | 20 | 20 |
| PBT-NEG-T187H | 30 | 30 | 30 |
| Sodium carbonate | — | — | 0.15 |
| LOXIOL P 861/3.5 | 0.455 | 0.455 | 0.455 |
| Total percentage | 100 | 100 | 100 |
| Laser Transmittance, @1064 nm, % | 22.3 | 28.294 | 50.008 |
| Tensile modulus, MPa | 1.01E+04 | 1.07E+04 | 1.10E+04 |
| Elongation at break, % | 3.1 | 2.3 | 2.2 |
| Tensile strength at break, MPa | 145 | 154 | 155 |
| Charpy, Notched at 23° C., KJ/m² | 9.6 | 7.8 | 8 |
| MVR (250° C., 2.16 kg), cc/10 min | 8.49 | 6.17 | 3.35 |
| HDT A (1.80 MPa), ° C. | 205 | 179 | 185 |
| HDT B (0.45 MPa), ° C. | 220 | 214 | 214 |

TABLE 4

| Component by wt. % | Comp. 1 | Comp. 10 | Comp. 11 |
|---|---|---|---|
| PBT 1100-211MB | 69.545 | 49.545 | 49.395 |
| PMMA ACRYREX ® CM-211 | — | 20 | 20 |
| PBT-NEG-T187H | 30 | 30 | 30 |
| Sodium Carbonate | — | — | 0.15 |
| LOXIOL P 861/3.5 | 0.455 | 0.455 | 0.455 |
| Total percentage | 100 | 100 | 100 |
| Laser Transmittance, @1064 nm, % | 22.3 | 16.7 | 23.2 |
| Tensile modulus, MPa | 1.01E+04 | 1.07E+04 | 1.09E+04 |
| Elongation at break, % | 3.1 | 2.3 | 2.0 |
| Tensile strength at break, MPa | 145 | 147 | 150 |
| Charpy, Notched at 23° C., KJ/m² | 9.6 | 8.5 | 7.3 |
| MVR (250° C., 2.16 kg), cc/10 min | 8.49 | 6.56 | 3.12 |
| HDT A (1.80 MPa), ° C. | 205 | 189 | 192 |
| HDT B (0.45 MPa), ° C. | 220 | 217 | 216 |

TABLE 5

| Component by wt. % | Comp. 12 | Comp. 13 | Comp. 14 | Exp. 7 | Exp. 8 |
|---|---|---|---|---|---|
| Ultradur B4500 | 100 | 79.5 | 79.5 | 79.5 | 79.5 |
| PP F401 | — | 20 | — | — | — |
| COC | — | — | 20 | — | — |
| SAN | — | — | — | 20 | — |
| PS POLYREX ® PG-383M | — | — | — | — | 20 |
| Sodium Carbonate | — | 0.5 | 0.5 | 0.5 | 0.5 |
| Total percentage | 100 | 100 | 100 | 100 | 100 |
| Laser Transmittance, | 13.7 | 10.3 | 18.5 | 23.14 | 36.45 |
| 1.4 mm, @980 nm, % | | | | | |

TABLE 6

| Component by wt. % | Exp. 9 | Exp. 10 | Exp. 11 |
|---|---|---|---|
| Ultradur B2550 | 44.45 | 44.45 | 44.45 |
| PS POLYREX ® PG-383M | 25 | 25 | 25 |
| ECS303(HL)303N-3 (D-Glass) | 30 | — | — |
| PBT-NEG-T187H (E-Glass) | — | 30 | — |
| CSG3PA820, (E-glass, flat GF) | — | — | 30 |
| Sodium Carbonate | 0.15 | 0.15 | 0.15 |
| LOXIOL P 861/3.5 | 0.3 | 0.3 | 0.3 |
| Irganox 1010 | 0.1 | 0.1 | 0.1 |
| Total percentage | 100 | 100 | 100 |
| Laser Transmittance, @1064 nm, % | 35.62 | 54.08 | 60.63 |
| Tensile modulus, MPa | 9.60E+03 | 1.07E+04 | 1.07E+04 |
| Elongation at break, % | 1.7 | 1.5 | 1.6 |
| Tensile strength at break, MPa | 119 | 120 | 126 |
| Charpy, Notched at 23° C., KJ/m² | 9.2 | 8.7 | 11 |
| MVR (275° C., 5 kg), cc/10 min | 88.5 | — | 41.9 |
| HDT A (1.80 MPa), ° C. | 190 | — | 192 |
| HDT B (0.45 MPa), ° C. | 216 | — | 215 |
| Dk/2.5 GHz | 3.11 | 3.35 | 3.34 |
| Df/2.5 GHz | 0.0050 | 0.0058 | 0.0052 |

1. A polybutylene terephthalate composition, comprising:
(A) a polybutylene terephthalate resin,
(B) an amorphous polymer having a refractive index of at least 1.55 and having no carbonate group in the repeating units of the amorphous polymer, the refractive index is measured at 25° C. and wavelength of 589 nm according to ASTM D542,
(C) an alkali metal carbonate and/or bicarbonate,
(D) an optional glass fiber, and
(E) an optional additive.

2. The polybutylene terephthalate composition according to claim 1, wherein the amorphous polymer (B) has a refractive index of from 1.55 to 1.60.

3. The polybutylene terephthalate composition according to claim 1, wherein the amorphous polymer is selected from the group consisting of polystyrene, styrene-acrylonitrile copolymer, amorphous copolyesters, and mixtures thereof.

4. The polybutylene terephthalate composition according to claim 1, wherein
the polystyrene comprises units derived from 50 mol % to 100 mol % of at least one monomer having the Formula I, based on total units of polystyrene: 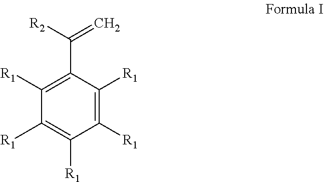
wherein R₁ is same or different and is selected from the group consisting of hydrogen, C₁-C₁₀ alkyl group, C₁-C₆ alkenyl group, C₄-C₁₀ cycloaliphatic group, C₆-C₁₂ aromatic hydrocarbon group, C₁-C₄ alkoxy group, and halogen atoms; R₂ is hydrogen and/or C₁-C₄ alkyl group;
styrene-acrylonitrile copolymer comprising:
(B.1) 50 to 99 parts by mass of vinyl aromatic monomer and/or ring-substituted vinyl aromatic monomer,
(B.2) 1 to 50 parts by mass of vinyl cyanide monomer;
and optionally (B.3) C₁-C₈ alkyl methacrylate, based on the total parts by mass of monomers of styrene-acrylonitrile copolymer; or
amorphous copolyester having at least two different repeating units RP₁ and RP₂ in a combined amount of at least 55 mol %, based on the total repeating units of the copolyester;
wherein the repeating unit RP₁ is derived from glycol and dicarboxylic acid, the dicarboxylic acid includes terephthalic acid and optionally other dicarboxylic acid, the repeating unit RP₂ is derived from glycol and dicarboxylic acid; a mole ratio of the glycol in the RP₁ to the glycol in the RP₂ is from 2:8 to 8:2.

5. The polybutylene terephthalate composition according to claim 4, wherein
Formula I is selected from the group consisting of styrene, alpha-methylstyrene, 2-methylstyrene, 3-methylstyrene, 4-methylstyrene, 2,4-dimethylstyrene, 2,5-dimethylstyrene, para-alpha-dimethylstyrene, 2-ethylstyrene, 3-ethylstyrene, 4-ethyl styrene, 2-isopropyl styrene, 3-isopropyl styrene, 4-isopropyl styrene, ortho-divinylbenzene, meta-divinylbenzene, para-divinylbenzene, ethoxy styrene, chlorostyrene, bromostyrene, dibromostyrene, dichlorostyrene, tribromostyrene, trichlorostyrene, 2-vinylnaphthalene, and 2-isopropenylnaphthalene,
styrene-acrylonitrile copolymer is selected from the group consisting of styrene/acrylonitrile copolymers, α-methylstyrene/acrylonitrile copolymers, styrene acrylonitrile-maleic anhydride copolymers, styrene-acrylonitrile-phenylmaleimide copolymers, α-methylstyrene-acrylonitrile-methyl methacrylate copolymers, α-methyl-styrene-acrylonitrile-t-butylmethacrylate copolymers, and styrene-acrylonitrile-t-butylmethacrylate copolymers.
the amorphous copolyester is cyclohexanedimethylene modified poly(ethylene terephthalate), ethylene modified poly(1,4-cyclohexanedimethylene terephthalate), or the mixture thereof.

6. The polybutylene terephthalate composition according to claim 1, wherein alkali metal carbonate and/or bicarbonate (C) is selected from the group consisting of sodium carbonate, sodium bicarbonate, potassium carbonate, and potassium bicarbonate.

7. The polybutylene terephthalate composition according to claim 1, wherein the polybutylene terephthalate resin (A) is in an amount of from 10 wt. % to 90 wt. %, based on the total weight of the polybutylene terephthalate composition.

8. The polybutylene terephthalate composition according to claim 1, wherein the amorphous polymer (B) is in an amount of from 1 wt. % to 50 wt. %, based on the total weight of the polybutylene terephthalate composition.

9. The polybutylene terephthalate composition according to claim 1, wherein the alkali metal carbonate and/or bicarbonate (C) is in an amount of from 0.01 wt. % to 10 wt. %, based on the total weight of the polybutylene terephthalate composition.

10. The polybutylene terephthalate composition according to claim 1, wherein the glass fiber (D) is in an amount of from 0 wt. % to 50 wt. %, based on the total weight of the polybutylene terephthalate composition.

11. The polybutylene terephthalate composition according to claim 1, wherein the glass fiber (D) is E-glass fiber and/or D-glass fiber.

12. The polybutylene terephthalate composition according to claim 1, wherein the additives (E) are in an amount of 0.01-15 wt. %, based on the total weight of the polybutylene terephthalate composition.

13. An article produced from the polybutylene terephthalate composition according to claim 1.

14. The article according to claim 13, wherein the article is a sensor, electric control unit, or advanced driver assistance system device for automobile.

15. A method for improving laser transmittance of a polybutylene terephthalate composition comprising application of an alkali metal carbonate and/or bicarbonate.

16. The method according to claim 15, wherein the polybutylene terephthalate composition comprises
(A) a polybutylene terephthalate resin,
(B) an amorphous polymer having a refractive index of at least 1.55 and having no carbonate group in the repeating units of the amorphous polymer, the refractive index is measured at 25° C. and wavelength of 589 nm according to ASTM D542,
(C) an alkali metal carbonate and/or bicarbonate,
(D) an optional glass fiber, and
(E) an optional additive.
